(19) United States
(12) Patent Application Publication
(10) Pub. No.: US 2007/0114786 A1
(43) Pub. Date: May 24, 2007

(54) Magnetic tag and method for reading information store therein

(76) Inventors: Alexandru Antonenco, Kishinev (MD); Arieh Geller, Kirian Ono (IL); Evgeni Sorkine, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 10/502,590

(22) PCT Filed: Jan. 23, 2003
(86) PCT No.: PCT/IL03/00060

§ 371 Date: May 6, 2005

(30) Foreign Application Priority Data
Jan. 24, 2002 (IL) 147813
Aug. 1, 2002 (IL) 151050

(51) Int. Cl. B42D 15/00

(52) U.S. Cl. 283/70

(57) ABSTRACT

A magnetic information-carrying tag is presented. The tag comprises a pair of spaced magnetic biasing elements magnetizable to create a magnetic field having a gradient within the space between the magnetic biasing elements, and an array of elongated magnetically soft elements accommodated in a spaced-apart substantially parallel relationship in the space between the magnetic biasing elements and defining a pattern indicative of the information carried in the tag.

### FIELD OF THE INVENTION

This invention relates to a magnetic identification tag and to a system and method for reading information stored in the tag.

### BACKGROUND OF THE INVENTION

Information-carrying magnetic tags are widely used for both the identification of products and the security purposes. These tags are able to carry a sufficient number of bits to provide useful information, such as product related information (e.g., name, date of manufacture, price, etc.), and information indicative of whether the product, article or person carrying the tag has properly passed through a check-out counter or kiosk, etc. The most popular examples of information-carrying multi-bit magnetic tags are magnetic strips and printed magnetic barcodes. Numerous examples of information-carrying magnetic tags and techniques for reading information from such tags are known in the art, and are disclosed for example in the following publications:

U.S. Pat. No. 4,940,966 describes a magnetic tag utilizing a plurality of magnetic elements in predetermined associations (e.g. with predetermined numbers of magnetic elements and with predetermined spacings between said elements), for identifying articles. When the articles are caused to move relative to a predetermined interrogating magnetic field, each particular association of magnetic elements gives rise to a magnetic signature whereby the article carrying each of the predetermined associations can be recognized and/or located.

Examples of such associations include (1) sets of hard and soft magnetic element pairs where the hard elements have various remanent magnetizations, and (2) several soft magnetic elements spaced at various distances from one or more hard magnetic elements. The hard magnetic element serves to bias the magnetic response of a soft element such that the center of the hysteresis loop of the soft magnetic element is displaced from the zero value of the applied field. In associations of type (1), the various pairs, having soft magnetic elements all spaced identically from their respective hard elements, will show various displacements from the zero value because of the various magnetizations shown by the hard elements, different combinations of which can characterize different objects. In associations of type (2), the various soft elements will experience different bias fields and show a variety of displacements from the zero value because of the difference in the distances to the biasing element.

U.S. Pat. No. 5,175,419 describes a technique for the identification of a magnetic tag having a plurality of magnetic, thin wires or thin bands which have highly rectangular hysteresis curves and different coercive forces. The magnetic tag can be identified by passing the tag through an alternating magnetic field to produce a pulse train corresponding to the magnetic tini wires or bands.

U.S. Pat. No. 5,729,201 describes a magnetic tag which uses an array of amorphous wires in conjunction with a magnetic bias field. The magnetic bias has been supplied either by coating each wire with a magnetically hard material which is magnetized or by using magnetized hard magnetic wires or foil strips in proximity to the amorphous wires. The tag is interrogated by the use of either a ramped or AC field. Each wire switches at a different value of the external interrogation field due to the differences in the magnetic bias field acting on each wire.

U.S. Pat. Nos. 5,736,929; 5,821,859 and 5,909,176 describe a magnetic tag using an array of individual magnetic elements that are closely spaced along an amorphous wire or strip. The magnetic elements take the form of magnetic ink, high coercivity wire, thin foil, or amorphous wire. The array is personalized (coded) by omitting certain elements of the array or driving selected elements to saturation while others remain demagnetized. The reading of the elements can be accomplished by moving a scannable head consisting of small magnetic circuits coupled to pickup loops along the tag.

U.S. Pat. Nos. 6,371,379 describes a magnetic marker or tag, which comprises (a) a first magnetic material characterized by high permeability, low coercivity and a non-linear B-H characteristic; and (b) a second magnetic material which is capable of being permanently magnetized. The second magnetic material is magnetized with a non-uniform field pattern and has at least three discrete regions of magnetic bias material. The label is interrogated by a low-frequency AC magnetic field with a simultaneously present low amplitude high-frequency AC magnetic field. The low frequency field has sufficient amplitude to overcome the local biasing created by the magnetized layer of the label. Since the bias levels are different in different regions, the bias can be overcome at different points (times) in the low frequency field scan.

WO0108085 discloses a technique for encoding and retrieving information by utilizing a magnetic tag including a number of ferromagnetic elements having different coercive forces which exhibit a detectable response upon the application of a magnetic field.

WO0129755 assigned to the assignee of the present application describes a security system including (i) a magnetic tag with a plurality of magnetic elements having extremely low coercivity (substantially lesser than 10A/m) and high permeability (substantially higher than 20000) and (ii) a reading head having a magnetic sensing element with two permanent magnets creating a static magnetic field of a specific configuration. This static magnetic field affects the magnetic elements so as to provide their magnetic response to this static field, and has such a configuration as to define an extended narrow region (plane) where the static magnetic field vector is substantially equal to zero. The sensing element is located substantially within the zero-field region, and is thereby responsive to signals generated by each of the magnetic elements, when the magnetic element is located in the zero-field region. The reading of the code pattern formed by the magnetic elements is carried out by the mechanical scanning of the pattern.

WO96/31790 and U.S. Pat Nos. 6,054,924 and 6,329,919 describe various magnetic tags divided into distinct magnetic zones, such that the zones and their relative positions can represent information or a code. Generally, these techniques exploit the difference between the magnetic behavior of the tag in (i) a zero field (at the magnetic null), and (ii) in a high, generally saturating, magnetic field. The magnetic null is defined by a point, line, plane or volume in space at or within which the component of the magnetic field in a given linear direction is zero. The tag can be readable magnetically either by moving the tag through a magnetic field which comprises a relatively small region of the zero magnetic field (a magnetic null), or by holding the tag in a fixed position while the magnetic field is scanned over it. During this relative movement, a magnetic response of the tag is detected as it traverses the magnetic null.

The main disadvantage of the above technique is its small information density. The responses of two magnetic elements of the tag cannot be discriminated if the spacing between the elements is lower than the size of the magnetic null zone. In practice, this zone could not be created smaller than several millimeters, thus providing an information density of about 2 bits per cm. Another disadvantage is in the strong dependence of the tag response on the position and the orientation of the tag relative to the reader head. While reading, the tag (or the reader head) must be moved strictly along the predetermined track Any variation in the tag's position or orientation with respect to the predetermined parameters may lead to the loss of information and errors in reading.

### SUMMARY OF THE INVENTION

There is a need in the art to facilitate multi-bit tagging by providing a novel information-carrying multi-bit magnetic tag, as well as a method and system of tag reading that does not need mechanical scanning of the tag.

The magnetic tag of the present invention comprises a set (array) of elongated elements made of a soft magnetic material, and a pair of elongated strips (constituting a pair of biasing elements) made of a hard magnetic material. The hard magnetic strips are magnetized along their length and in opposite directions, thereby forming a magnetic field biasing with a gradient between the strips. The elongated soft magnetic elements are accommodated in a spaced-apart relationship substantially in parallel to one another and to the hard magnetic strips, and are located in a zone (region) of the tag between the hard magnetic strips. The magnetic field created by the hard magnetic field thus has a gradient in the region between the hard magnetic strips, and thus each soft magnetic element experiences a different magnetic biasing. Having been subjected to an interrogating AC magnetic field, each of the soft magnetic elements will respond at a different moment depending on the element position in the tag, and hence the responses of the soft magnetic elements (sequence of pulses) to the interrogating magnetic field will represent information stored in the tag. The magnetic field biasing with a gradient allows for tag reading without the need for any mechanical or electronic scanning of the tag.

The magnetic tag of the present invention can be easily read without direct contact in a wide range of distances and orientations with respect to the reader head According to one embodiment of the present invention, the number of the soft magnetic elements in the set (array) and a predetermined spacing therebetween is representative of the information stored in the tag.

According to another embodiment of the present invention, the magnetic tag further comprises a layer formed of a magnetic material located underneath the magnetically soft elements, and a predetermined number of the elongated magnetically soft elements are placed at equal distances therebetween. Respective areas of the under-layer overlapping selected areas of the magnetically soft elements are magnetized, and respective areas of the under-layer overlapping remaining ones of the magnetically soft elements are not magnetized. The relative positions of the magnetized and non-magnetized areas of the under-layer can define the information stored in the tag.

According to yet another embodiment of the present invention, the tag configuration is such that the magnetically soft elements have different magnetic characteristics. For example, the magnetically soft elements can be of first and second types: the elements of the first type provide a frequency response to an interrogating magnetic field different from that of the elements of the second type.

It is important for the purposes of the present invention that each magnetically soft element experiences a permanent magnetic shift created exclusively by the internal components of the tag (magnetically hard strips). Therefore, the magnetic shift is strictly fixed and does not depend on the tag position or its orientation. Due to this feature, the tag may be read in a wide range of positions and orientations.

Moreover, the hard magnetic strips located in close proximity to the soft magnetic elements change their magnetic states precisely, so that the response of two closely placed magnetic elements may be easily discriminated.

The information-carrying multi-bit magnetic tag according to the present invention has substantially lower dimensions and higher information density in comparison with the tags known in the art.

The information-carrying multi-bit magnetic tag according to the present invention may be easily and efficiently manufactured, with a low manufacturing cost.

The information-carrying multi-bit magnetic tag according to the present invention is of durable and reliable construction.

Thus, in accordance with one broad aspect of the invention, there is provided a magnetic information-carrying tag comprising: a pair of spaced magnetic biasing elements magnetizable to create a magnetic field having a gradient within the space between the magnetic biasing elements, and an array of elongated magnetically soft elements accommodated in a spaced-apart substantially parallel relationship in the space between the magnetic biasing elements and defining a pattern indicative of the information carried in the tag.

In the tag according to the invention, each of the magnetically soft elements is subjected to a different magnetic biasing as compared to the other elements. Thus, simultaneous subjecting all the magnetically soft elements to an interrogation AC magnetic field results in a response pattern, formed by responses of said elements to said field at different moments in time depending on the elements relative positions in the tag.

The stored information can be defined by the spacings between the adjacent magnetically soft elements in the tag.

The elongated magnetically soft elements may be equally spaced from each other, and located on an under-layer formed of a magnetic material, e.g., ferromagnetic material. This under-layer has a pattern formed by magnetized regions spaced by non-magnetizes regions, such that some of the magnetically soft elements are located above the magnetized regions of the under-layer, and the other magnetically soft elements are located above the non-magnetized regions of the under-layer, said pattern defining the information stored in the tag. The construction may be such that the elongated magnetically soft elements are equally spaced from each other and have different magnetic characteristics, thereby defining a pattern indicative of the information stored in the tag. The elongated magnetically soft elements may be equally spaced from each other, and include the magnetically soft elements of first and second types providing different frequency responses to an interrogating magnetic field, respectively.

Each of said biasing elements includes at least one elongated magnetically hard strip, preferably having a coercive force in the range of 5000 to 30000 A/m and reminence in the range of 0.2 to 2 T. The magnetically hard strips are accommodated in a substantially parallel relationship and substantially parallel to the elongated magnetically soft elements, such that the array of soft magnetic elements is enclosed between two hard strips. The biasing elements may be strips of ARNOKROME III alloy.

The elongated magnetically soft elements preferably have a coercive force lower than 5 A/m and a magnetic permeability greater than 20000. The soft magnetic elements may be glass-coated amorphous magnetic microwires.

According to another aspect of the invention, there is provided a method of reading information stored in the magnetic information tag configured as described above. The method comprises: (a) applying an interrogating AC magnetic field to the tag, so as to simultaneously subject all of the soft magnetic elements in the tag to said interrogating AC magnetic field and produce a response pattern of the soft magnetic elements to said AC magnetic field indicative of the information stored in the tag; (b) detecting said response pattern, and (c) analyzing the response pattern to determine said information.

The interrogating AC magnetic field may comprise at least two frequency components of substantially different frequencies. In this case, the response has at least two harmonics corresponding to these two frequency components. The information thus can be determined by calculating a ratio between said two harmonics.

According to yet another aspect of the invention, there is provided a method enabling authentication of an article, the method comprising:
assigning the article with a unique identification code and storing a data portion representative of this identification code in a database;
applying to said article the tag of any one of claims 1-14 with the pattern indicative of said unique identification code, thereby enabling comparison of a data portion representative of the tag response to an interrogation AC magnetic field and a data portion representative of the unique identification code.

According to yet another aspect of the invention, there is provided a system for use in identification or authentication of an article by utilizing the tag configured as described above and applied to the article, and a reading head. The reader head includes an interrogating coil wound on a C-core, a first generator coupled to the interrogating coil for providing an AC current thereto to thereby create an interrogating AC magnetic field to be applied to said tag, two pickup coils configured to detect a response of the magnetically soft elements to said interrogating AC magnetic field, and generate signals indicative thereof and a signal processor for receiving and analyzing data indicative of said signals and determining the information stored in the tag from the signals indicative of the response of the magnetically soft elements to said interrogating AC magnetic field.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of an information-carrying multi-bit tag, according to the invention;

FIG. 2 shows two coding combinations of soft magnetic elements;

FIG. 3 illustrates a distribution of the magnetic field at the surface of the tag;

FIG. 4 illustrates a schematic view of a system for reading information stored in the tag, according to one embodiment of the present invention;

FIG. 5A illustrates a hysteresis loop of the magnetic soft elements;

FIG. 5B illustrates the effect of the DC bias magnetic field on the response of a magnetically soft element;

FIG. 6 illustrates a typical response of the tag;

FIG. 7 illustrates another embodiment of the tag, according to the invention;

FIG. 8 illustrates the effect magnetization of the under-layer on the response of a magnetically soft element;

FIG. 9 illustrates another embodiment of the tag, according to the present invention;

FIG. 10 shows an example of the responses of the magnetically soft elements of the tag shown in FIG. 9;

FIGS. 11A and 11B illustrate hysteresis loops of the two types of the magnetically soft elements utilized in the tag shown in FIG. 9; and

FIG. 12 illustrates a schematic view of a system for reading information stored in the tag shown in FIG. 9.

### DETAILED DESCRIPTION OF THE INVENTION

The principles and operation of the information-carrying multi-bit magnetic tag according to the present invention may be better understood with reference to the drawings and the accompanying description, it being understood that these drawings and examples in the description are given for illustrative purposes only and are not meant to be limiting. The same reference numerals will be utilized for identifying those components which are common in the multi-bit magnetic tags shown in the drawings throughout the present description of the invention.

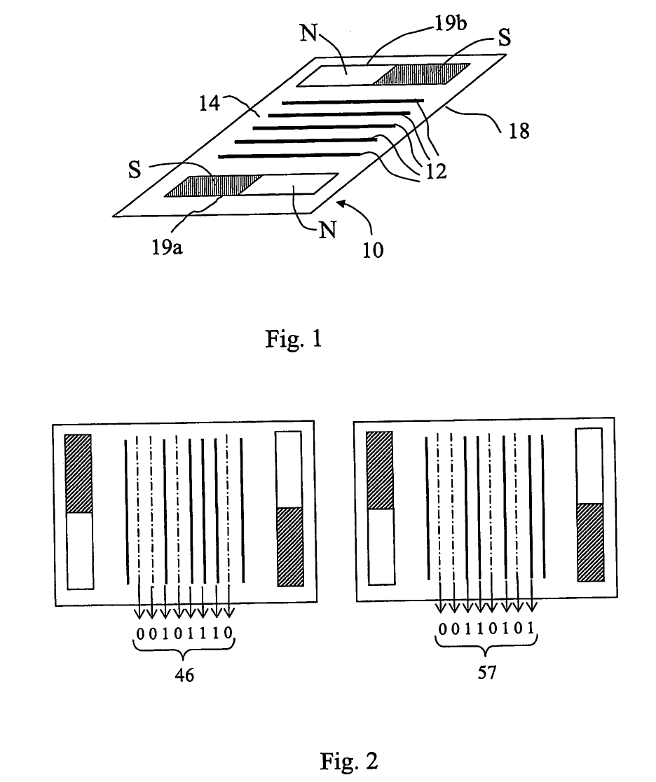

Referring to FIG. 1, there is illustrated an example of an information-carrying multi-bit magnetic tag 10 according to the invention. The tag 10 comprises a substrate 18 to which a pair of magnetically hard strips 19a and 19b (constituting a pair of biasing elements) and a set (array) of elongated magnetically soft elements 12 are attached. The elongated magnetically soft elements 12 are accommodated in a spaced-apart relationship, substantially in parallel to one another and to the hard magnetic strips 19a and 19b, in zone 14 of the tag 10 between the strips 19a and 19b.

Generally, narrow and thin amorphous ribbons, foil, film or wires may be used as materials for the magnetically soft elements 12. Preferably, the soft magnetic elements are amorphous glass-coated microwires similar to that described in WO0129755 assigned to the assignee of the present applicant. The magnetically hard material for the strips 19a and 19b may be chosen in accordance with the particular product requirements. For example, thin strips of ARNOKROME III alloy produced by the Arnold Group may be used for strips 19a and 19b.

For example, the elongated magnetically hard strips 19a and 19b have coercive force in the range of 5000 to 30000 A/m and reminence in the range of 0.2 to 2 T. The elongated magnetically soft elements 12 have coercive force smaller than 5 A/m and magnetic permeability greater than 20000.

In accordance with one embodiment of the present invention, the set of spatially separated elongated magnetically soft elements 12 has a predetermined number of these elements. Certain mutual spacing between adjacent elements in the set is characteristic of the information (e.g., the code) that is stored in the tag 10.

FIG. 2 illustrates two examples of the characteristic patterns formed by the magnetic elements 12. The magnetically soft elements 12 occupy a set of determined positions in accordance with the minimum distance between them. For instance, the diameter of the magnetic elements 12 can be chosen between 10 and 50 microns, while the minimum distances between the magnetic elements 12 can be chosen between 0.2 and 1 mm. Each position of the magnetically soft element represents an information bit In other words, if the magnetically soft element occupies a specific position relative to the hard magnetic strips, then this position will represent “1”. Otherwise, the position will represent “0”. The number of bit storage positions needed for a particular application is therefore chosen to represent in binary form at least the number of bits of information to be carried by the tag. Preferably, the positions corresponding to the first and last magnetic elements in the array are used as reference.

For example, the patterns shown in the FIG. 2 represent the binary codes “00101110” and “00110101”, which are equivalent to the decimal values 46 and 57, respectively. In this example, the positions 21 and 22 are used as reference and not assigned to carry information.

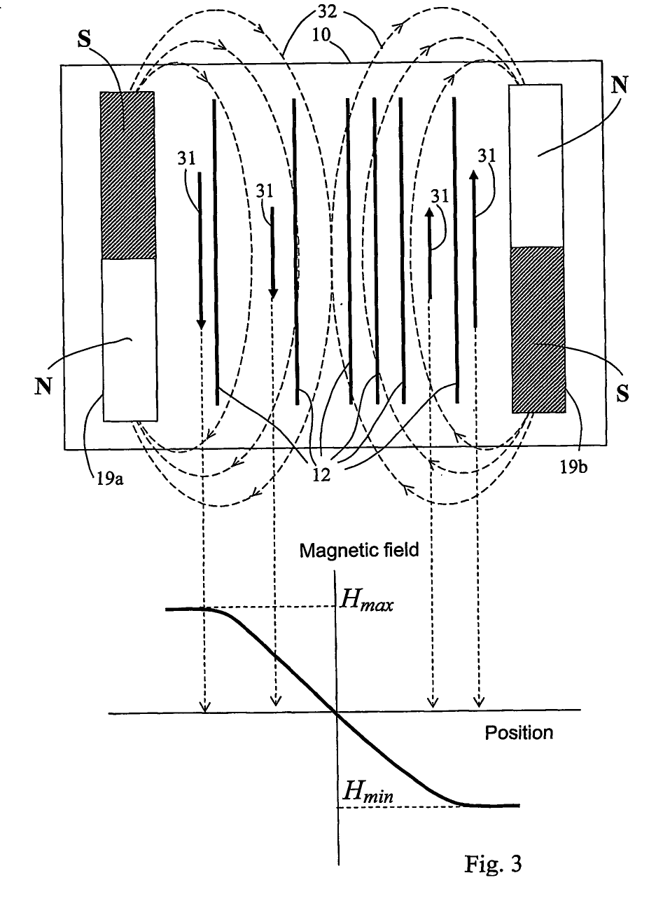

Referring to FIG. 3, the distribution of a magnetic field on the surface of the information-carrying multi-bit magnetic tag 10 is illustrated. In accordance with this example of the present invention, the magnetically hard strips 19a and 19b are magnetized along their length and in opposite directions. Having been magnetized in such a way, the magnetically hard strips 19a and 19b create a permanent magnetic field with a gradient between the strips in the middle area of the tag 10.

As can be appreciated, each of the magnetically hard strips 19a and 19b creates in its vicinity a longitudinal magnetic component 31 of a DC magnetic field that is directed along the strips 19a and 19b. A magnetic flux corresponding to the strips 19a and 19b is represented diagrammatically by drawing flux lines 32. The highest strength of this longitudinal component of the DC magnetic field Hₘₐₓ is in the area adjacent to the strips 19a and 19b. As long as the distance from the strips 19a and 19b increases, the strength of the longitudinal component 31 becomes lower. In the middle M of the tag 10, the longitudinal components 31 of the DC magnetic field created by the left and the right strips are of exactly equal strength. Thus, due to the opposite magnetization of the 19a and 19b, the resulting field strength in the middle plane M is zero. When passing from the left strip to the right, the vertical component of the magnetic field sweeps from the magnitude of Hₘₐₓ to the magnitude of Hₘᵢₙ. It should be noted that for this example Hₘᵢₙ=−Hₘₐₓ.

The information or code stored in the tag may be read by subjecting the tag to an interrogating AC magnetic field and detecting responses of the soft magnetic elements to the interrogating field. The response pattern is indicative of the information or code stored in the tag.

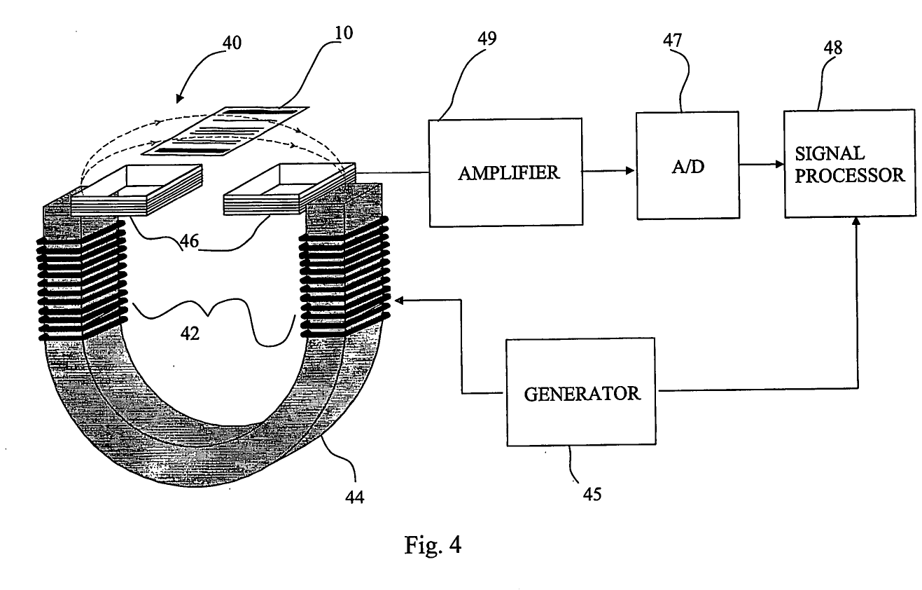

FIG. 4 illustrates a schematic view of a system 40 for reading information (e.g., a code) stored in the tag, according to one embodiment of the present invention. It should be noted that the blocks in FIG. 4 are intended as functional entities only, such that the functional relationships between the entities are shown, rather than any physical connections and/or physical relationships.

The system 40 includes an interrogating coil 42 wound on a C-core 44, a generator 45 coupled to the interrogating coil 42 for providing AC current thereto, two pickup coils 46 coupled to an amplifier 49, an analog-to-digital (A/D) converter 47 coupled to the amplifier 49 and a signal processor 48 coupled to the generator 45 for synchronization and to the analog-to-digital converter 47. The two pickup coils 46 are configured to detect a response of the magnetically soft elements 12 of the tag 10.

In operation, the tag 10 is subjected to an interrogating AC magnetic field created by the interrogating coil 42. A signal representative of the information from the tag 10 is detected by the pickup coils 46 and transmitted to the amplifier 49. The amplified signal is fed to the A/D converter 47, and a respective digital signal generated by the A/D converter 47 is fed to the signal processor 48 for extracting this information.

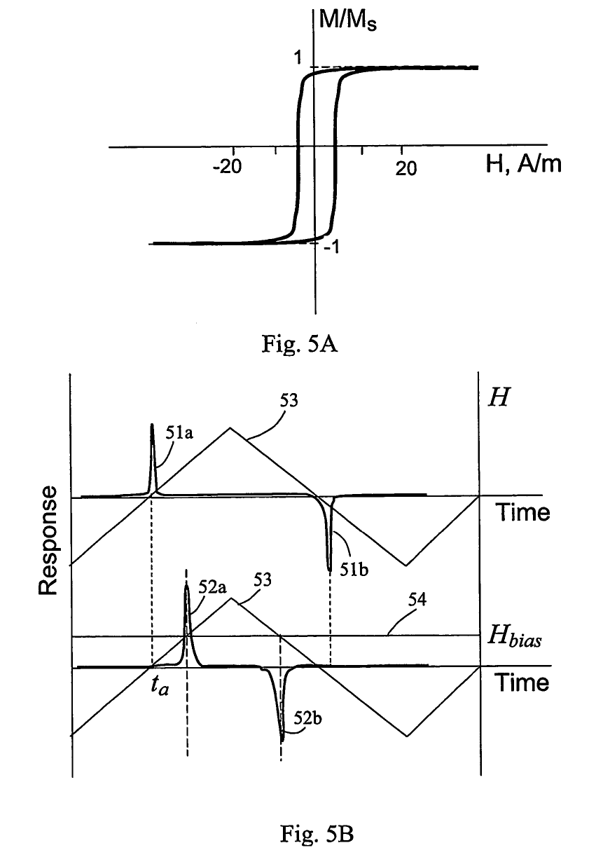

FIG. 5A and FIG. 5B illustrate the physical principle of reading the information code stored in the tag. The magnetically soft elements 12 employed in the tag 10 are characterized by narrow, nearly square hysteresis loop (see FIG. 5A). When subjected to the external alternating (AC) magnetic field 53, this element can be re-magnetized each time, as the interrogating AC magnetic field changes its polarity.

The magnetic field disturbance caused by the re-magnetization of the magnetically soft element will generate sharp voltage pulses 51a and 51b having direct and reverse polarities, correspondingly, in the pick-up coils (see FIG. 5B). If in addition to the alternating magnetic field 53, a bias DC magnetic field 54 is applied to the soft magnetic element 12, then the latter will be re-magnetized at the moments when the strength of the alternating field reaches the strength of the bias DC magnetic field. Consequently, the positions of the voltage pulses 52a and 52b will be shifted in time, when compared with the position of the voltage pulse 51a and 51b. Thus, the direct polarity pulse 52a will be delayed relative to the moment tₐ at which the alternative magnetic field changes its polarity, while the reverse polarity pulse 52b will be ahead of the aforementioned moment tₐ.

As indicated above, the magnetically hard strips 19a and 19b of the tag 10 create a gradient of the permanent (DC) magnetic field at the tag surface plane, e.g., a linear gradient of the DC magnetic field. Therefore, the magnitude of the bias DC magnetic field applied to each magnetically soft element 12 depends on the position of the element 12 in the tag 10 relative to the strips 19a and 19b. Consequently, each element 12 will respond to the interrogating AC field at a different moment of time, and the positions of pulses on the time scale will strictly correspond to the relative spatial positions of the elements 12 in the tag 10 that enable the reading of the tag without any displacement of the tag relatively the DC magnetic field (i.e., without a mechanical or electronic scanning).

The frequency of the interrogating AC field produced by the coil 42 may, for example, be in the range of about 50 Hz to 5000 Hz, preferably about 400 Hz. The amplitude of the interrogating AC field must be higher than the DC component of the magnetic field in the vicinity of the extreme left and the extreme right soft magnetic component.

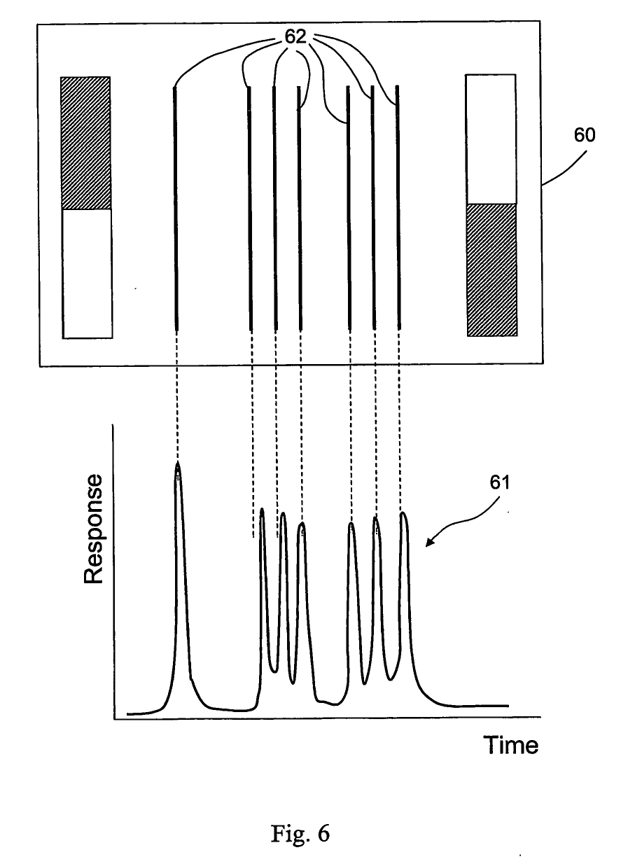

Referring to FIG. 6, a typical response 61 of a magnetic tag 60 is illustrated. It is quite clear to those skilled in the art that for the given tag 60 the response 61 can reconstruct the positions of soft magnetic elements 62 in the tag 60, and thereby define the encoded information or code stored therein.

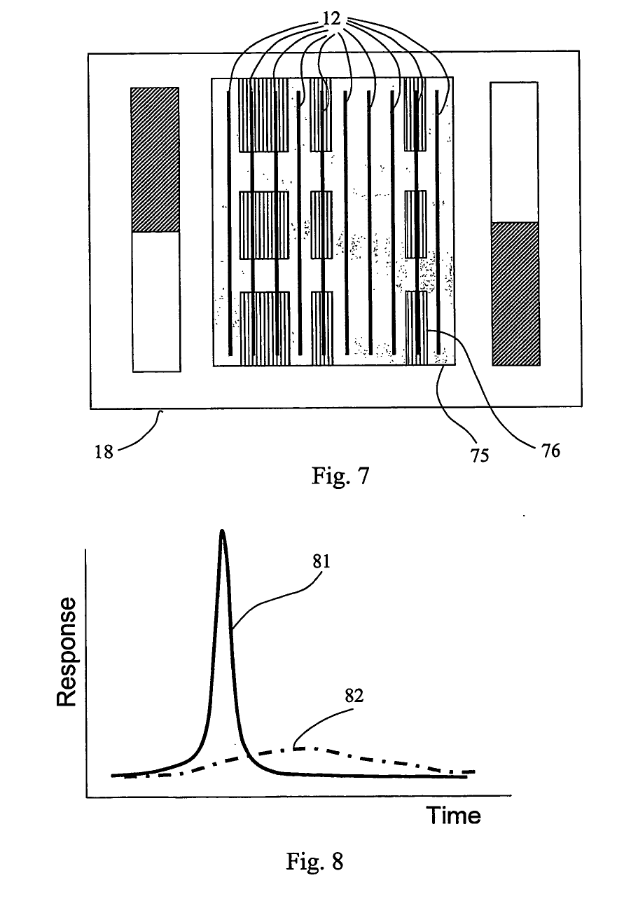

Referring now to FIG. 7, another embodiment of the tag 10 in accordance with the present invention is illustrated. The tag includes the substrate 18 on which the set of the magnetically soft elements 12 is mounted together with the pair of the magnetically hard strips 19a and 19b, magnetized in opposite directions and located at opposite sides of the array 12. The tag of FIG. 10, in distinction to the previous example, comprises an under-layer 75 formed of a magnetic material deposited onto the substrate 18, and the magnetically soft elements 12 are placed on top of the under-layer 75. Preferably, the under-layer 75 has a relatively high coercive force (e.g., in the range of 10⁵ A/m to 5-10⁵ A/m). The thickness of the under-layer 75 may be in the range of 20 microns to 100 microns. For example, the under-layer 75 can be formed of a ferromagnetic material. In particular, it may be a layer of magnetic paint widely used for magnetic cards and tickets.

In the example of FIG. 10, the tag 10 contains a definite number of the soft magnetic elements 12 which are placed at equal distances therebetween. The information or code is stored in the tag by magnetizing predetermined areas of the under-layer 75 at predetermined regions 76 overlapping a selected number of the magnetically soft elements 12 and leaving remaining areas of the under-layer 75 not magnetized. The magnetization of the portions 76 is carried out in the direction coinciding with the direction of the soft magnetic elements 12. The response of the soft magnetic elements 12 thus depends substantially on the condition of the under-layer 75.

FIG. 8 shows the effect of the under-layer 75 on the response of the magnetically soft element 12. When the under-layer 75 is not magnetized, the magnetic field disturbance caused by re-magnetization of the magnetically soft element 12 generates a sharp voltage pulse. In other words, the non-magnetized under-layer 75 does not affect the response of the soft magnetic element 12 to an interrogating magnetic field. However, when a region of the under-layer 75 below a specific soft magnetic element is magnetized to a sufficient value, the response of this soft magnetic element is totally suppressed. Thus, a code to be stored in the tag can be created by magnetizing the regions of the magnetic layer 75 under selected soft magnetic elements and leaving non-magnetized layer regions under the rest of the elements. The relative positions of the magnetized and non-magnetized areas (regions) of the under-layer 75 will thus define the information stored in the tag. The above-described system 40 and method can be used for reading the information stored in this tag.

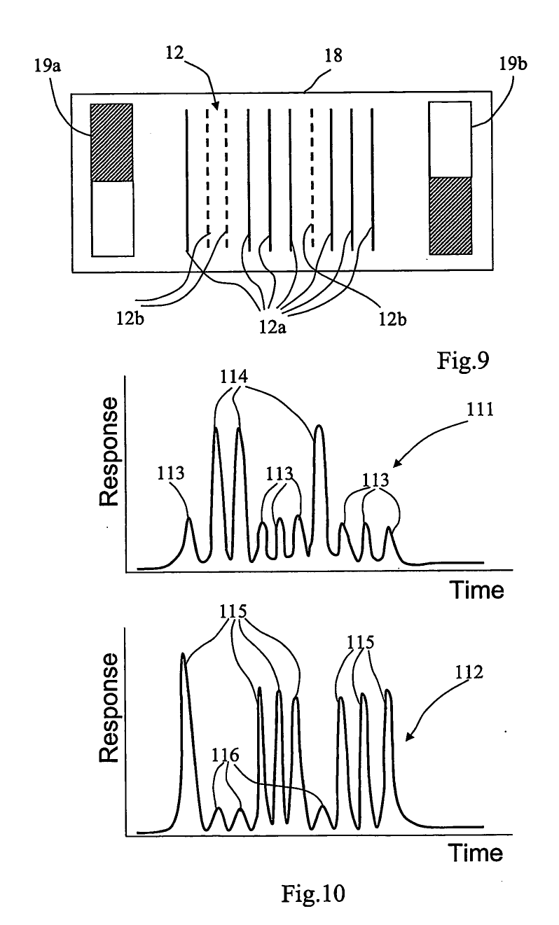

Referring now to FIG. 9, yet another embodiment of the tag 10 in accordance with the present invention is illustrated. Generally, this tag includes the substrate 18 on which the set of the magnetically soft elements 12 is mounted together with the pair of the magnetically hard strips 19a and 19b magnetized in opposite directions. However, according to this embodiment of the invention, the tag contains a definite number of the soft magnetic elements 12 which are placed at equal distances therebetween. In this embodiment, information is stored into the tag by employing the magnetically soft elements 12 having different magnetic characteristics, for example, the magnetically soft elements 12 of two types. The magnetically soft elements 12a of the first type are shown in FIG. 9 by solid lines, while the magnetically soft elements 12b of the second type are shown by dashed lines.

The magnetic elements 12a and 12b provide substantially different frequency responses to an interrogating magnetic field. FIG. 10 shows an example of the responses of the elements 12a and 12b at first 111 harmonics and second 112 harmonics. As can be seen, the amplitude of first harmonics 113 for the elements 12a is smaller than the amplitude of first harmonics 114 for the elements 12b. On the other hand, the amplitude of second harmonics 115 for the elements 12a is higher than the amplitude of second harmonics 115 for the elements 12b.

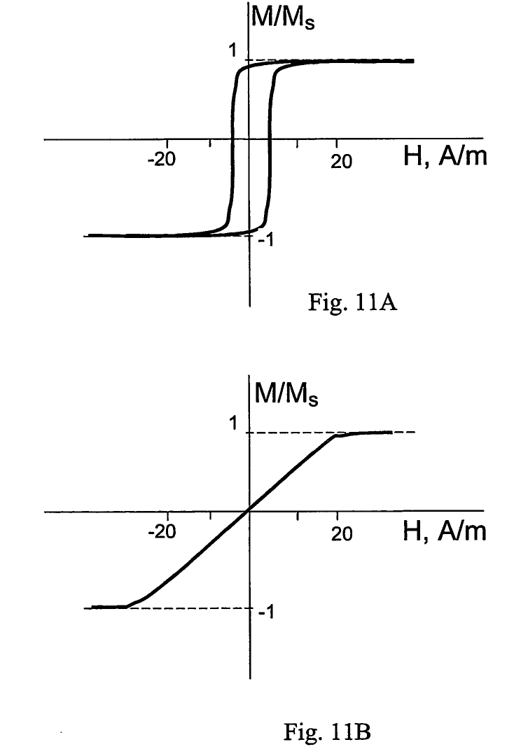

FIGS. 11A and FIG. 11B exemplify the hysteresis loops of the magnetically 25 soft elements 12a of the first type and magnetically soft elements of 12b the second type, respectively. The elements 12a and 12b can thus represent “1” and “0”, respectively. For example, the arrangement of the elements 12a and 12b shown in FIG. 9 represents the binary code “1001110111”, which is equivalent to the decimal value 631.

The information stored in the tag of FIG. 9 can be read in the following manner. The tag is subjected to an interrogating AC magnetic field that comprises two components of substantially different frequencies. The response of the soft magnetic elements having at least two harmonics corresponding to the two frequency components are detected, and the stored information is determined by calculating the ratio between the first and second harmonics.

In accordance with the embodiment of FIG. 9, the magnetically soft elements 12a and 12b are subjected to the DC magnetic field, created by the pair of hard magnetic strips 19a and 19b and having a gradient in the tag surface plane, so that each soft magnetic element has its own magnetic bias. Accordingly, each soft magnetic element, when exposed, for example, to the low frequency interrogating field, will sweep through the state of its highest permeability at a different time moment depending on its position relative to the hard magnetic strips. There will be a strict correspondence between the harmonics response of the tag in the time scale and the relative positions of the magnetically soft elements 12a and 12b. The ratio between the first and second harmonics is determined by the magnetic properties of the particular soft magnetic element, and its value can indicate a bit (“1” or “0”) attributed to the element.

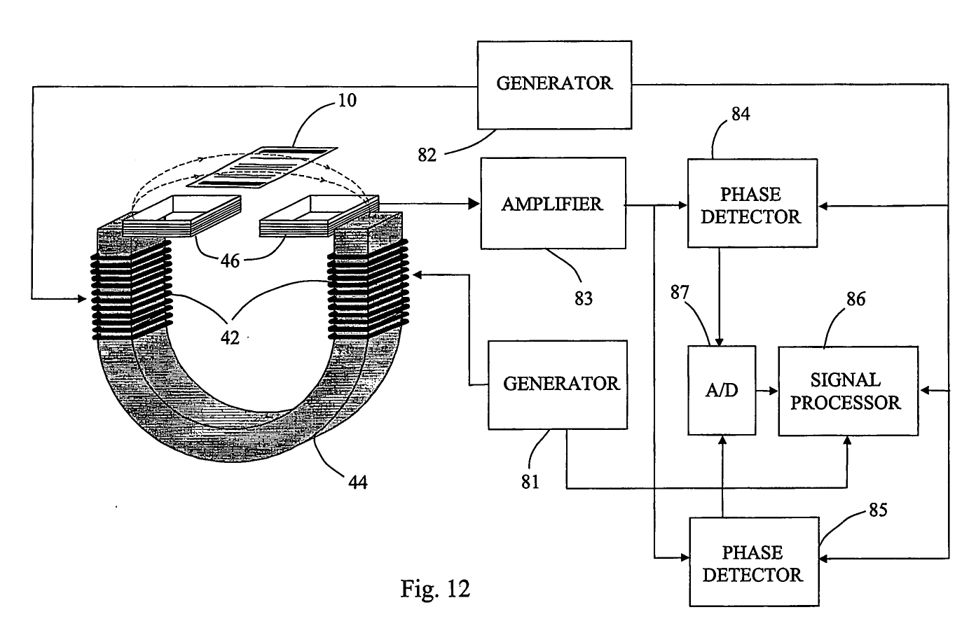

FIG. 12 exemplifies a system 110 for reading information stored in the tag of FIG. 9. It should be noted that the blocks in FIG. 12 are intended as functional entities only, such that the functional relationships between the entities are shown, rather than any physical connections and/or physical relationships. The system 110 includes an interrogating coil 42 wound on a C-core 44, a first generator 81 and a second generator 82 coupled to the interrogating coil 42 for providing an AC current of substantially different frequencies and amplitudes thereto. The coil 42 wound on the C-core 44 produces an interrogating AC magnetic field comprising two frequency components. The system 110 also includes two pickup coils 46 configured for detecting the response of the magnetically soft elements 12 of the tag 10, an amplifier 83 coupled to the pickup coils 46, a first phase detector 84 and a second phase detector 85 coupled to the amplifier 83. Further provided in the system 110 are an A/D converter, and a signal processor (SP) 86 coupled to the AID converter, to the phase detectors 84, 85 and to the generators 81 and 82.

In operation, a signal detected by the pickup coils 46 is transmitted to the amplifier 53, and the amplified signal is transmitted to the phase detectors 84 and 85 locked at the first and second harmonics of the high frequency component of the AC interrogating field. The phase detectors 84 and 85 produce output signals proportional to the amplitudes of the first and second harmonics, correspondingly. These output signals are fed to the A/D converter, and thereafter to the signal processor 86 which operates to extract the tag information from the received signal.

According to this embodiment of the invention, the lower frequency of the interrogating AC field may, for example, be in the range of 50 Hz to 5000 Hz, preferably about 400 Hz. The higher frequency of an AC interrogating field may, for example, be in the range of 10 Hz to 100 kHz, preferably about 30 kHz. The amplitude of the lower frequency component of the interrogating field must be higher than the DC component of the magnetic field in the vicinity of both the extreme left and the extreme right soft magnetic elements.

It should be appreciated that the magnetic tag of the present invention, namely, a tag utilizing a pair of elongated magnetically hard strips magnetized along their length and in opposite directions thereby forming a magnetic field biasing with a gradient between the strips, where the array of soft-magnetic elements is located, is characterized by information density substantially higher than the known tags. In particular, it was found that the distance between the soft magnetic elements might be as small as 0.2 mm. It means that a tag having the width of 1 cm may contain up to 50 information bits.

Moreover, the magnetic tag of the present invention may be read at a substantial distance from the pick-up coils and in a wide range of orientations and positions relative to the pick-up coils. Actually, the main restriction on the tag position or orientation is related to the amplitude of the interrogating field in the direction of the magnetic elements. Hence, the tags may be read in any position or direction, provided the component of the interrogating field in the direction of magnetic elements is higher than the maximum DC field applied to the magnetic element. These features are achieved due to the provision of the aforementioned radient of the DC magnetic field (produced by elongated magnetically hard strips) so that the magnetically soft elements of the tag are subjected to the magnetic bias independently of the tag position or orientation with respect to a reader system (reader head).

It should be appreciated that the spatially separated elongated magnetically soft elements 12, the pair of magnetically hard strips 19a, 19b and, when required, the under-layer 75 can be bonded directly to the substrate 18 (e.g. paper or plastic material) to form self-supporting tags. Alternatively, the elongated magnetically soft elements 12, the pair of magnetically hard strips 19a, 19b (and optionally the under-layer 75) may be incorporated into the structure of an article with which the tag is to be associated. Thus, a tag may be formed in situ with the article in question by applying the elongated magnetically soft elements 12, the pair of magnetically hard strips 19a, 19b (and optionally the under-layer 75) to the surface of the article, or by embedding these components within the body of the article.

For example, the multi-bit tag of the present invention can be bond to an ID photo by utilizing special adhesive composition and/or laminates. Alternatively, the multi-bit tag can be embedded directly within the plastic body of an ID card. In both cases, the multi-bit tag cannot be removed from the article (document) without being destroyed.

Hence, the multi-bit tag of the present invention can be used for verifying the authenticity of the article. The multi-bit tag can be encoded with a certain number being in correspondence with the article ID number. In the simplest case, the encoded number can itself be the ID number of the article to be authenticated. The encoded number, the ID number and all other necessary attributes associated with the article can be entered in a database. The verification of authenticity of the article can be carried out by checking the correspondence between the number encoded in the multi-bit tag and the number of the ID article stored in the database. The presence of the multi-bit tag on the article and coincidence of the encoded number with the ID number can, for example, be considered as two conditions required for ID validation. Thus, a reading system (its processor) is preprogrammed to analyze a data portion indicative of the detected response pattern with respect to a data portion representative of the preset ID number, and generate a signal indicative of whether these data portions match each other or not.

Those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

It is apparent that although only one interrogating and two pickup coils is utilized in the reading systems exemplified above, the number of the interrogating and pickup coils is not restricted to any specific number. For example, for enhancing the system sensitivity, more interrogating and pickup coils can be used.

Moreover, any reference to a specific implementation in terms of usage of the AC current generators, A/D converter, phase detectors, processor, or any other components of the systems for reading information stored in the tag are shown by way of a non-limiting example.

Also, it is to be understood that the phraseology and terminology employed herein are for the purpose of description and should not be regarded as limiting.

It is important, therefore, that the scope of the invention is not construed as being limited by the illustrative embodiments set forth herein. Other variations are possible within the scope of the present invention as defined in the appended claims and their equivalents.

1. A magnetic information-carrying tag comprising a pair of spaced magnetic biasing elements magnetizable to create a magnetic field having a gradient within the space between the magnetic biasing elements, and an array of elongated magnetically soft elements accommodated in a spaced-apart substantially parallel relationship in the space between the magnetic biasing elements and defining a pattern indicative of the information carried in the tag.

2. The tad according to claim 1, wherein each of the magnetically soft elements is subjected to a different magnetic biasing as compared to the other elements, simultaneous subjecting of all the magnetically soft elements to an interrogation AC magnetic field thereby resulting in a response pattern formed by responses of said elements to said field at different moments of time depending on the elements relative positions in the tag.

3. The tag of claim 1 wherein the information is defined by the spacings between the adjacent magnetically soft elements.

4. The tag of claim 1 wherein said elongated magnetically soft elements are equally spaced from each other, and are located on an under-layer formed of a magnetic material.

5. The tag of claim 4 wherein said under-layer is formed of a ferromagnetic material.

6. The tag of claim 4 wherein said under-layer has a pattern formed by magnetized regions spaced by non-magnetizes regions, such that some of the magnetically soft elements are located above the magnetized regions of the under-layer, and the other magnetically soft elements are located above the non-magnetized regions of the under-layer, said pattern defining the information stored in the tag.

7. The tag of claim 1 wherein said elongated magnetically soft elements are equally spaced from each other and have different magnetic characteristics, thereby defining a pattern indicative of the information stored in the tag.

8. The tag of claim 1 wherein said elongated magnetically soft elements are equally spaced from each other, and include the magnetically soft elements of first and second types providing different frequency responses to an interrogating magnetic field, respectively.

9. The tag of claim 1 wherein each of said biasing elements includes at least one elongated magnetically hard strip, the magnetically hard strips being accommodated in a substantially parallel relationship and substantially parallel to the elongated magnetically soft elements.

10. The tag of claim 1 wherein said elongated magnetically soft elements have a coercive force lower than 5 A/m and magnetic permeability greater than 20000.

11. The tag of claim 1 wherein each of said biasing elements includes at least one elongated magnetically hard strip having a coercive force in the range of 5000 to 30000 A/m and reminence in the range of 0.2 to 2 T.

12. The tag of claim 1 wherein said elongated magnetically soft elements are glass-coated amorphous magnetic microwires.

13. The tag of claim 1 wherein said biasing elements are in the form of strips of ARNOKROME III alloy.

14. The tag of claim 1 wherein said array of the spaced-apart elongated magnetically soft elements and said biasing elements are supported on a substrate.

15. The tag of claim 1 wherein said array of the spaced-apart elongated magnetically soft elements and said pair of biasing elements are incorporated into a structure of an article with which the tag is associated.

16. A method of reading information stored in the magnetic information tag of claim 1 the method comprising:
(a) applying an interrogating AC magnetic field to the tag, so as to simultaneously subject all of the soft magnetic elements in the tag to said interrogating AC magnetic field and produce a response pattern of the soft magnetic elements to said AC magnetic field indicative of the information stored in the tag;
(b) detecting said response pattern, and
(c) analyzing the response pattern to determine said information.

17. The method of claim 16 wherein the soft magnetic elements respond to said field at different moments of time depending on the elements relative positions in the tag.

18. The method of claim 16 wherein said interrogating AC magnetic field comprises at least two frequency components of substantially different frequencies.

19. The method of claim 18 wherein said response has at least two harmonics corresponding to said two frequency components.

20. The method of claim 19 wherein the determining of said information includes calculating a ratio between said two harmonics.

21. A method enabling authentication of an article, the method comprising: assigning the article with a unique identification code and storing a data portion representative of this identification code in a database;
applying to said article the tag of claim 1 with the pattern indicative of said unique identification code, thereby enabling comparison of a data portion representative of the tag response to an interrogation AC magnetic field and a data portion representative of the unique identification code.

22. A system for use in identification or authentication of an article, the system comprising the tag of claim 1 applied to the article, and a reading head comprising:
(a) an interrogating coil wound on a C-core,
(b) a first generator coupled to the interrogating coil for providing an AC current thereto to thereby create an interrogating AC magnetic field to be applied to said tag,
(c) two pickup coils configured to detect a response of the magnetically soft elements to said interrogating AC magnetic field, and generate signals indicative thereof,
(d) a signal processor for receiving and analyzing data indicative of said signals and determining the information stored in the tag from the signals indicative of the response of the magnetically soft elements to said interrogating AC magnetic field.

23. An article carrying the tag of claim 1, the article being thereby identifiable or authenticable by applying of an interrogation AC magnetic field to the article to thereby simultaneously subject all the magnetically soft elements to said field, and producing a response pattern indicative of relative positions of said elements in the tag indicative of the information stored in the tag.
